(19) United States
(12) Patent Application Publication
(10) Pub. No.: US 2013/0077041 A1
(43) Pub. Date: Mar. 28, 2013

(54) EYEGLASSES HAVING REPLACEABLE AND FOLDABLE TEMPLES

(71) Applicant: Lin Chun Chih, Tapei (TW)

(72) Inventor: Lin Chun Chih, Tapei (TW)

(21) Appl. No.: 13/246,661

(22) Filed: Sep. 27, 2011

(51) Int. Cl. G02C 5/14

(52) U.S. Cl. 351/116

(57) ABSTRACT

Disclosed is a pair of eyewear that may be used as sunglasses or protective eyewear. The eyewear comprise removable arms so that the arms or frame may be replaced by the user.

### BACKGROUND

Eyeglasses can have an element of fashion and style as well as function. There are several uses for eyeglasses including protecting the eyes, shading the eyes, and correcting vision. In addition, eyeglasses are often used for fashion purposes.

### SUMMARY

An embodiment of the present invention may therefore comprise eyewear having foldable and replaceable temples comprising: two lenses; a frame surrounding the lenses; at least one arm so that the arm can be removed and replaced; at least one release mechanism that is secured to a hinge plate so that the at least one release mechanism receives the at least one arm and the release mechanism has a flange and a decreased diameter; a locking plate having grasping arms so that the grasping arms attach to release mechanism; a retention spring disposed to engage the release mechanism, so that when the retention spring is compressed the grasping arms shift from the flange to the decreased diameter on the release mechanism so that the grasping arms are released from the flange to the decreased diameter and the at least one arm is released and the at least one arm can be removed and replaced; a release button disposed to engage the release mechanism, so that the release button compresses the retention spring to allow the at least one arm to be removed; at least one hinge secured by a fastener so that the at least one hinge attaches to the frame and a hinged plate connector so that the at least one hinge allows the hinged plate connector and the at least one receiving mechanism to move in a direction towards the release button.

An embodiment of the present invention may therefore further comprise a method of changing a temple arm from a frame of eyewear having foldable and replaceable temples comprising: providing two lenses; providing a frame surrounding the lenses; providing at least one arm so that the at least one arm may be removed and replaced from the frame; providing at least one release mechanism that is secured to a hinge plate so that the at least one release mechanism receives the at least one arm and the receiving mechanism has a flange and a decreased diameter portion; providing a locking plate having grasping arms so that the grasping arms attach to a release mechanism; compressing a retention spring so that when the retention spring is compressed the grasping arms shift from the flange to the decreased diameter portion on the release mechanism so that the grasping arms are released from the flange to the decreased diameter so that at least one arm is released and the at least one arm can be removed and replaced; pressing a release button located adjacent to the at least one release mechanism so that the release button allows the at least one arm to be removed; providing a hinge secured by a fastener so that the hinge attaches to the frame and a hinged plate connector so that the hinge allows the hinged plate connector and the at least one release mechanism to move in a direction towards the release button.

### BRIEF DESCRIPTION OF THE DRAWINGS

FIG. 1 is an isometric view of eyeglasses with foldable and replaceable temples.

FIG. 2A is an isometric close-up view of eyeglasses 101 of FIG. 1 having a transparent arm.

FIG. 2B is an isometric view of FIG. 2A having an arm that is not transparent.

FIG. 3 is an isometric assembly view of FIG. 2A.

FIG. 4A is a cross-sectional view of release mechanism and retention pin of FIG. 3.

### DETAILED DESCRIPTION

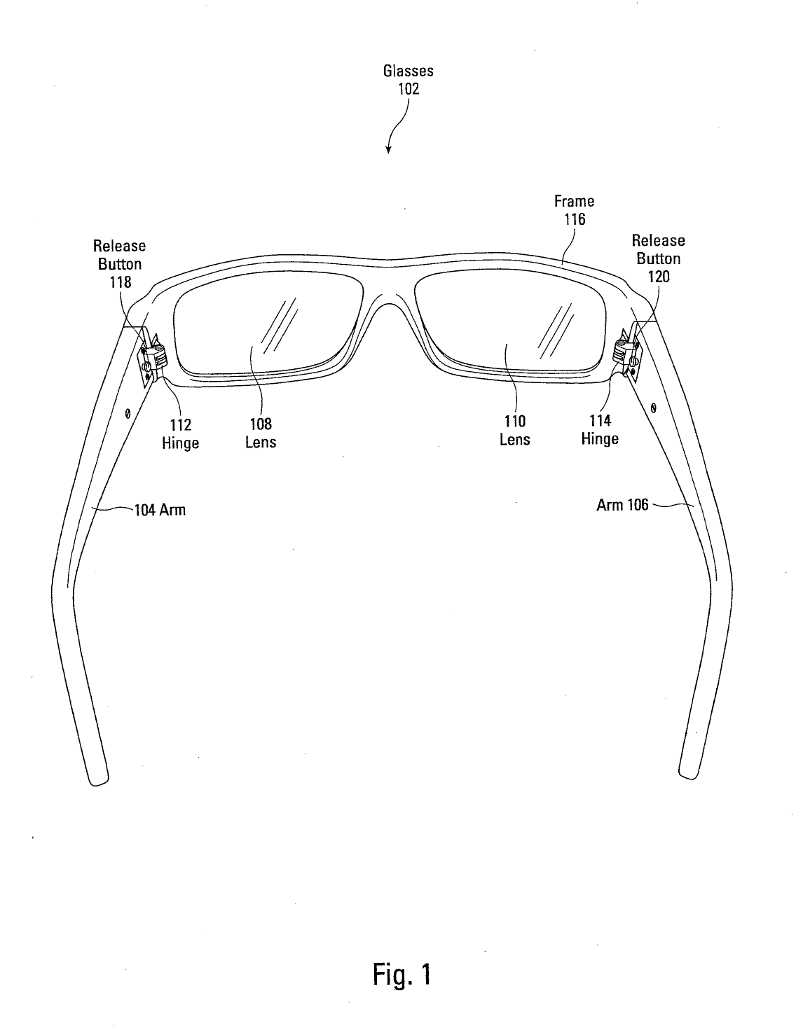

FIG. 1 is an isometric view of glasses 102. Glasses 102 have arm 104 and arm 106 that are constructed so that arm 104 and arm 106 can be disconnected from the frame portion 116. Frame portion 116 has lens 108 and lens 110 so that lens 108 and lens 110 may have either clear lenses or tinted lenses. Lenses 108, 110 may be corrective lenses or non-corrective lenses. Glasses 102 may be used as, but is not limited to, a fashion accessory or a protective cover for eyes. Arm 104 and arm 106 are foldable at hinge 112 and hinge 114, respectively. Arm 104 and arm 106 are capable of being separated from frame 116. For example, pressing release button 118 releases arm 104 and pressing release button 120 releases arm 106. Arm 104 and arm 106 may be embellished with special designs so that the user considers them to be fashionable or desirable according to the use of the user. Arm 104 and arm 106 may also have various shapes, colors, embellished and can be transparent to display the internal elements of arm 104, 106. In addition, frame 116 may have various shapes, colors and employ various embellishments and designs. For example, a user may desire to have a collection of various frames 116 having lenses 108, 110 made of different materials such as glass, plastic as well as some lenses 108, 110 to be polarized, or having a prescription lens, as well as clear lenses. In that way, a user may mix and match frame 116 with arms 104, 106 in accordance with their needs and fashionable desires. In addition, if a lens 108, 110 becomes scratched or damaged in any way, the user can easily replace frame 116 without having to buy new arms 104, 106. Frame 116, lens 108, 110, and arms 104, 106 may be customized and embellished to meet both fashionable and functional desires.

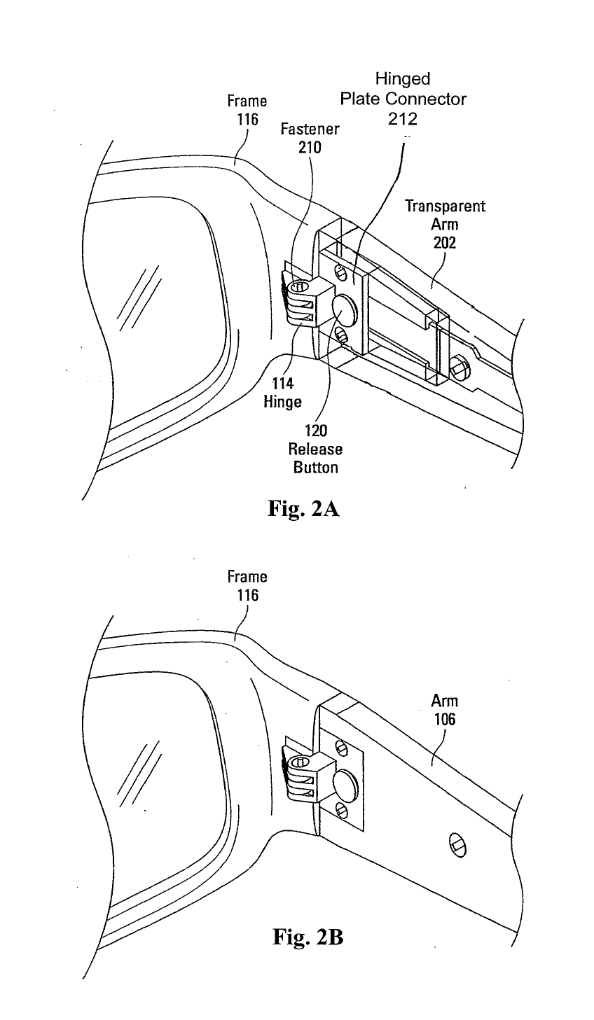

FIG. 2A is an isometric view showing frame 116 and hinge 114 that is secured by fastener 210. Hinge 114 allows movement of hinged plate connector 212 so that hinge plate connector 212 may move in an inward direction toward frame 116. Hinged plate connector 212 also comprises release button 120, which allows the release of transparent arm 202. In a similar manner, FIG. 2B is an isometric view of glasses 102 having frame 116 and arm 106. Arm 106 is not transparent, however, both arms 202, 106 may be embellished with various designs and fancy materials such as gold and diamonds and may be of any color not limited to any designs, shapes or colors.

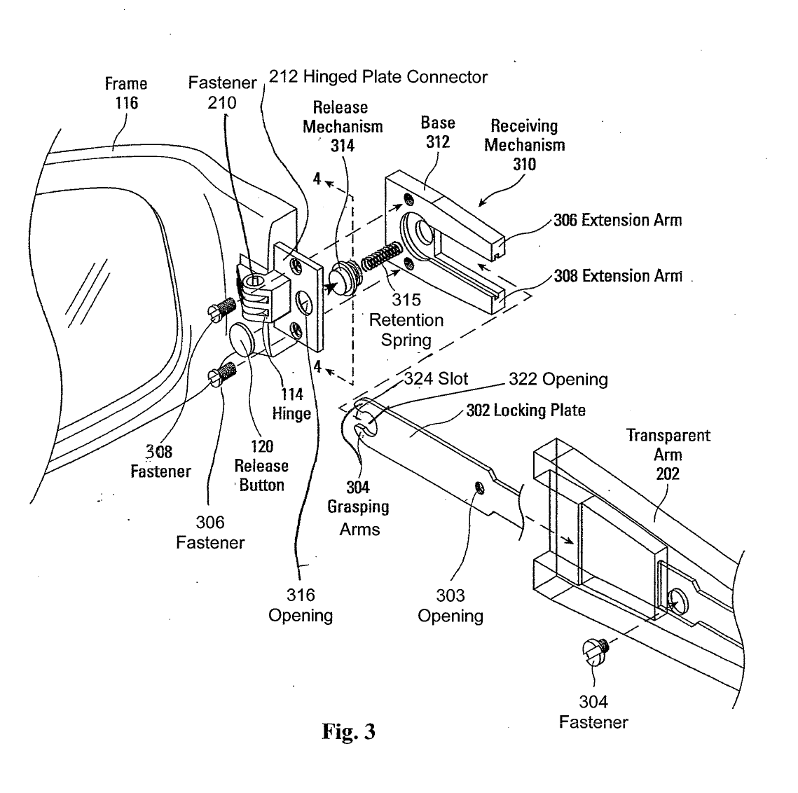

FIG. 3 is an isometric assembly view of FIG. 2A. FIG. 3 shows frame 116 having hinge 114 secured by fastener 210 so that hinged plate connector 212 may move in an inwardly direction toward release button 120. Hinged plate connector 212 connects with receiving mechanism 310. Receiving mechanism 310 comprises base 312 and extension arm 306, 308. Hinged plate connector 212 is secured to receiving mechanism 310 by fastener 308 and fastener 306 so that receiving mechanism 310 can move inwardly toward frame 116. Hinged plate connector 212 also comprises release button 120, release mechanism 314, and retention spring 315. Base 312 of receiving mechanism 310 comprises retention device 315 which may comprise, but is not limited, to a spring so that release mechanism 314 compresses retention spring 315 between base 312 and release mechanism 314. Release mechanism 314 protrudes through opening 316 so that release button 120 is secured to release mechanism 314. Release mechanism 314 may be secured to release button 120 by, processes comprising soldering, adhesively securing, binding, and other mechanical connections known in the art.

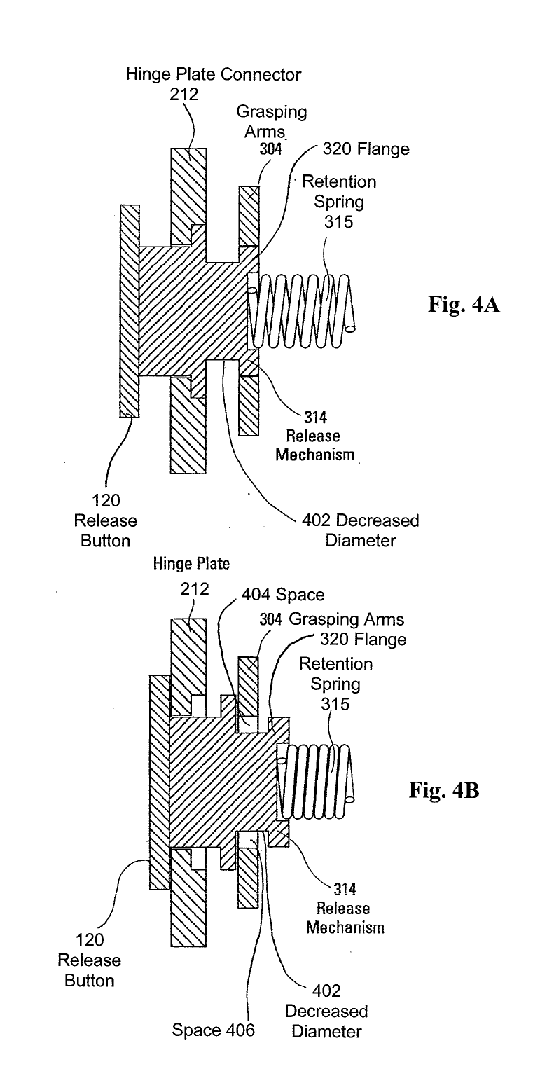

In operation, release button 120 is pressed so that release mechanism 314 moves towards retention spring 315 so that grasping arms 304 of transparent arm 202 may be released from receiving mechanism 310. In other words, grasping arms 304 form an opening 322 and a slot 324. Slot 324 has a decreased opening when compared to the diameter of opening 322. When release button 120 is pushed towards release mechanism 314, retention spring 315 is compressed which allows opening 322 to shift on release mechanism 314 to a decreased diameter (FIG. 4) on release mechanism 314 so that the slot 324 between grasping arms is able to easily slide off of release mechanism 314. If grasping arms 304 are not aligned with a decreased diameter (FIG. 4) of release mechanism 314, slot 324 is unable to release the release mechanism 314 because the distance between grasping arms 304 is too narrow to be released from release mechanism 314. In other words, opening 322 allows locking plate to be locked on release mechanism in the locked position. While locking plate 302 is in the locked position, the slot 324 between grasping arms 304 is too narrow to allow locking plate to be released from release mechanism 314.

Locking plate 302 has an opening 303 so that locking plate 302 can be secured within transparent arm 202 by fastener 304. In other words, locking plate 302 resides inside transparent arm 202, and fastener 304 secures locking plate 302 through opening 303 to transparent arm 202.

FIG. 4A is a cross-sectional view of FIG. 3 in an assembled position so that grasping arms 304 is in a locked position on release mechanism 314. Flange 320 retains the grasping arms 304 when retention spring 315 is in the extended position. To release grasping arms 304, release button 120 must be pressed so that retention spring 315 is in a compressed position and grasping arms 304 slide to decreased diameter 402 of release mechanism 314. FIG. 4A also shows release mechanism 314 flush against hinge plate connector 212.

FIG. 4B is the same cross-sectional view of FIG. 4A except that grasping arms 304 are in the release position. Grasping arms 304 are not retained by Flange 320. In other words, release button 120 has been pressed so that release mechanism 314 causes retention spring 315 to be compressed and release button 120 is flush against hinge plate 316. In addition, grasping arms 304 are no longer retained by flange 320. Grasping arms 304 are located at decreased diameter 402, having space 404, 406, so that grasping arms 304 can be released from release mechanism 314.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. Eyewear having foldable and replaceable temples comprising:
two lenses;
a frame surrounding said lenses;
at least one arm so that said arm can be removed and replaced;
at least one release mechanism that is secured to a hinge plate so that said at least one release mechanism receives said at least one arm and said release mechanism has a flange and a decreased diameter;
a locking plate having grasping arms so that said grasping arms attach to release mechanism;
a retention spring disposed to engage said release mechanism, so that when said retention spring is compressed said grasping arms shift from said flange to said decreased diameter on said release mechanism so that said grasping arms are released from said flange to said decreased diameter and said at least one arm is released and said at least one arm can be removed and replaced;
a release button disposed to engage said release mechanism, so that said release button compresses said retention spring to allow said at least one arm to be removed;
at least one hinge secured by a fastener so that said at least one hinge attaches to said frame and a hinged plate connector so that said at least one hinge allows said hinged plate connector and said at least one receiving mechanism to move in a direction towards said release button.

2. The eyewear of claim 1 wherein said at least one arm is embellished with materials.

3. The eyewear of claim 1 wherein said at least one arm is of various colors.

4. A method of changing a temple arm from a frame of eyewear having foldable and replaceable temples comprising:
providing two lenses;
providing a frame surrounding said lenses;
providing at least one arm so that said at least one arm may be removed and replaced from said frame;
providing at least one release mechanism that is secured to a hinge plate so that said at least one release mechanism receives said at least one arm and said release mechanism has a flange and a decreased diameter portion;
providing a locking plate having grasping arms so that said grasping arms attach to a release mechanism;
compressing a retention spring so that when said retention spring is compressed said grasping arms shift from said flange to said decreased diameter portion on said release mechanism so that said grasping arms are released from said flange to said decreased diameter so that at least one arm is released and said at least one arm can be removed and replaced;
pressing a release button located adjacent to said at least one release mechanism so that said release button allows said at least one arm to be removed;
providing a hinge secured by a fastener so that said hinge attaches to said frame and a hinged plate connecter so that said hinge allows said hinged plate connector and said at least one release mechanism to move in a direction towards said release button.

5. The method of claim 4 wherein said at least one arm is embellished with materials.

6. The method of claim 4 wherein said at least one arm is of various colors.
